(19) United States
(12) Patent Application Publication
(10) Pub. No.: US 2007/0067204 A1
(43) Pub. Date: Mar. 22, 2007

(54) Enterprise Economic Modeling

(76) Inventors: Scott Brown, Atlanta, GA (US); Andrew March, Reading, PA (US); Lorenzo Mantegazza, Como (IT); Kevin M. Kobel, Cape Elizabeth, ME (US); Karen Crennan, Como (IT)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(21) Appl. No.: 11/275,810

(22) Filed: Jan. 30, 2006

Related U.S. Application Data
(60) Provisional application No. 60/716,620, filed on Sep. 13, 2005.

(51) Int. Cl. G07G 1/00

(52) U.S. Cl. 705/10

(57) ABSTRACT

Computer-implemented methods and systems are provided for predicting how business decisions will impact an enterprise. A group of models may be used to model aspects of an enterprise and business units over a multiyear period. Models relating to different business parameters may be linked so that it may be determined how business decisions that result in a change to an input to one model impact aspects of the enterprise that are not modeled by the model. An iterative process may be used to obtain optimal results.

This application claims the benefit of U.S. Provisional Application No. 60/716,620, filed Sep. 13, 2005, the entire disclosure of which is hereby incorporated by reference.

### FIELD OF THE INVENTION

This invention relates generally to enterprise economic modeling. More particularly, the invention provides methods and systems for modeling a variety of different aspects of an enterprise over a multiyear period so that the impact of business decisions may be predicted over the multiyear period.

### DESCRIPTION OF RELATED ART

As an enterprises increases in size it becomes difficult for the enterprises to ensure that business decisions are consistent with the overall goals of the enterprise. A large enterprise may consist of several distinct business units. Each business unit attempts to maximize the profits of the business unit, which is assumed to maximize the profits of the enterprise. During the course of business each business unit may make business decisions that impact the enterprise and other business units. For example, an enterprise may set a limit on the number of new employees hired in a given year. A first business unit might make a decision regarding how many employees to hire in a year, which may impact the number of employees a second business unit can hire in the same time period. The allocation of employees within the enterprise is one factor that impacts the profitability of the enterprise.

The margin of an enterprise may be impacted by a number of other factors, such as the type of equity programs offered to employees, the allocation of resources between business units, etc. Existing computer systems and software applications do not allow business decision makers to effectively predict how decisions made regarding one business unit will impact the enterprise and other business units over a multiyear period. Without such systems and applications business decision makers are left to speculate on how a decision will impact a variety of enterprise business parameters, such as the margin of a business unit and the margin of the enterprise.

Therefore, there is a need in the art for systems and methods that allow business decision makers to predict how a decision will impact business units and an enterprise over a multiyear period.

### BRIEF SUMMARY OF THE INVENTION

Embodiments of the invention overcome problems and limitations of the prior art by providing computer implemented systems and methods that model economic aspects of an enterprise over a multiyear period. After agreeing on models and modeling assumptions, such as pricing; costs; target workforce mix; senior executive pyramids; selling, general and administrative expense (SG&A) targets; equity program structure; etc., business decision makers may then use one or more of the models modules to predict how business decisions will impact the economic health and vitality of an enterprise over a multiyear period.

In a first embodiment of the invention, a computer-implemented method for predicting business parameter values for an enterprise and business units within the enterprise is provided. The business parameters may include revenue targets, workforce parameters, expense parameters, profitability parameters, etc. A module receives a set of assumptions and accesses at least one model. Enterprise and business unit business parameter values are calculated by applying the assumptions to the model.

In another embodiment of the invention, a computer-implemented method of determining a target headcount for an enterprise having a plurality of business units is provided. The method includes receiving target revenue for each of the business units and selecting a headcount model for each of the business units. Head count model assumptions for the selected headcount models are also received. A computer device is then used to calculate a target headcount for the enterprise and each of the business units by applying the headcount model assumptions and target revenue to the selected headcount models.

In other embodiments of the invention, computer-executable instructions for performing one or more of the disclosed methods may be stored are stored on a computer-readable medium, such as a floppy disk or CD-ROM.

### BRIEF DESCRIPTION OF THE DRAWINGS

The present invention is illustrated by way of example and not limited in the accompanying figures in which like reference numerals indicate similar elements and in which:

FIG. 1 shows a typical prior art workstation and communication connections.

FIG. 2 is a high level diagram of a computer application that allows business decision makers to predict how a business decision will impact an enterprise over a multiyear time period, in accordance with an embodiment of the invention.

FIG. 3 shows a diagram of a computer system for generating workforce data, in accordance with an embodiment of the invention.

FIG. 4 illustrates exemplary steps performed by a worker-attributed revenue workforce model, in accordance with an embodiment of the invention.

FIG. 5 illustrates exemplary steps performed by an outsourcing workforce model, in accordance with an embodiment of the invention.

FIG. 6 illustrates a process that may be performed by a workforce module, in accordance with an embodiment of the invention.

FIG. 7 illustrates a system for calculating the impact of an equity program on an enterprise over a multiyear period, in accordance with an embodiment of the invention.

FIG. 8 shows a diagram of a system for generating data that indicates how an equity program will impact shareholders, in accordance with an embodiment of the invention.

FIG. 9 shows a diagram of a system for generating data relating to the dilution impact of an equity program, in accordance with an embodiment of the invention.

FIG. 10 shows a diagram of a system for generating data relating to how an equity program impacts an enterprise, in accordance with an embodiment of the invention.

FIG. 11 illustrates assumptions and formulas used to implement a model for determining the impact of an equity program on shareholders, in accordance with an embodiment of the invention.

FIG. 12 illustrates exemplary assumptions and formulas that may be used to implement a model that determines the dilution impact of an equity program, in accordance with an embodiment of the invention.

FIG. 13 illustrates exemplary assumptions and formulas that may be used to implement a model that determines how an equity program impacts an enterprise, in accordance with an embodiment of the invention.

FIG. 14 shows a system in which a user may request estimates of economic parameters via a wide area network, in accordance with an embodiment of the invention.

FIG. 15 illustrates a method that may be performed by a computer device to predict business parameters, in accordance with an embodiment of the invention.

### DETAILED DESCRIPTION

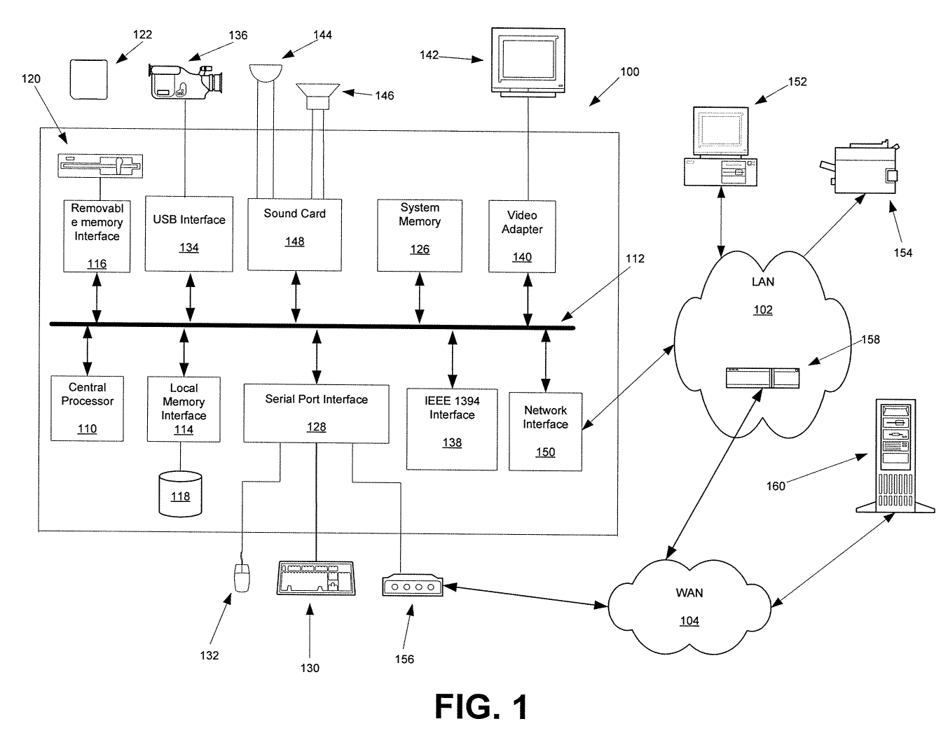

Various embodiments of the present invention may be implemented with computer devices and systems that exchange and process data. Elements of an exemplary computer system are illustrated in FIG. 1, in which the computer 100 is connected to a local area network (LAN) 102 and a wide area network (WAN) 104. Computer 100 includes a central processor 110 that controls the overall operation of the computer and a system bus 112 that connects central processor 110 to the components described below. System bus 112 may be implemented with any one of a variety of conventional bus architectures.

Computer 100 can include a variety of interface units and drives for reading and writing data or files. In particular, computer 100 includes a local memory interface 114 and a removable memory interface 116 respectively coupling a hard disk drive 118 and a removable memory drive 120 to system bus 112. Examples of removable memory drives include magnetic disk drives and optical disk drives. Hard disks generally include one or more read/write heads that convert bits to magnetic pulses when writing to a computer-readable medium and magnetic pulses to bits when reading data from the computer readable medium. A single hard disk drive 118 and a single removable memory drive 120 are shown for illustration purposes only and with the understanding that computer 100 may include several of such drives. Furthermore, computer 100 may include drives for interfacing with other types of computer readable media such as magneto-optical drives.

Unlike hard disks, system memories, such as system memory 126, generally read and write data electronically and do not include read/write heads. System memory 126 may be implemented with a conventional system memory having a read only memory section that stores a basic input/output system (BIOS) and a random access memory (RAM) that stores other data and files.

A user can interact with computer 100 with a variety of input devices. FIG. 1 shows a serial port interface 128 coupling a keyboard 130 and a pointing device 132 to system bus 112. Pointing device 132 may be implemented with a hard-wired or wireless mouse, track ball, pen device, or similar device.

Computer 100 may include additional interfaces for connecting peripheral devices to system bus 112. FIG. 1 shows a universal serial bus (USB) interface 134 coupling a video or digital camera 136 to system bus 112. An IEEE 1394 interface 138 may be used to couple additional devices to computer 100. Furthermore, interface 138 may configured to operate with particular manufacture interfaces such as FireWire developed by Apple Computer and i.Link developed by Sony. Peripheral devices may include touch sensitive screens, game pads scanners, printers, and other input and output devices and may be coupled to system bus 112 through parallel ports, game ports, PCI boards or any other interface used to couple peripheral devices to a computer.

Computer 100 also includes a video adapter 140 coupling a display device 142 to system bus 112. Display device 142 may include a cathode ray tube (CRT), liquid crystal display (LCD), field emission display (FED), plasma display or any other device that produces an image that is viewable by the user. Sound can be recorded and reproduced with a microphone 144 and a speaker 146. A sound card 148 may be used to couple microphone 144 and speaker 146 to system bus 112.

One skilled in the art will appreciate that the device connections shown in FIG. 1 are for illustration purposes only and that several of the peripheral devices could be coupled to system bus 112 via alternative interfaces. For example, video camera 136 could be connected to IEEE 1394 interface 138 and pointing device 132 could be connected to USB interface 134.

Computer 100 includes a network interface 150 that couples system bus 112 to LAN 102. LAN 102 may have one or more of the well-known LAN topologies and may use a variety of different protocols, such as Ethernet. Computer 100 may communicate with other computers and devices connected to LAN 102, such as computer 152 and printer 154. Computers and other devices may be connected to LAN 102 via twisted pair wires, coaxial cable, fiber optics or other media. Alternatively, radio waves may be used to connect one or more computers or devices to LAN 102.

A wide area network 104, such as the Internet, can also be accessed by computer 100. FIG. 1 shows a modem unit 156 connected to serial port interface 128 and to WAN 104. Modem unit 156 may be located within or external to computer 100 and may be any type of conventional modem, such as a cable modem or a satellite modem. LAN 102 may also be used to connect to WAN 104. FIG. 1 shows a router 158 that may connect LAN 102 to WAN 104 in a conventional manner. A server 160 is shown connected to WAN 104. Of course, numerous additional servers, computers, handheld devices, personal digital assistants, telephones and other devices may also be connected to WAN 104.

The operation of computer 100 and server 160 can be controlled by computer-executable instructions stored on a computer-readable medium. For example, computer 100 may include computer-executable instructions for transmitting information to server 160, receiving information from server 160 and displaying the received information on display device 142. Furthermore, server 160 may include computer-executable instructions for transmitting hypertext markup language (HTML) or extensible markup language (XML) computer code to computer 100.

As noted above, the term “network” as used herein and depicted in the drawings should be broadly interpreted to include not only systems in which remote storage devices are coupled together via one or more communication paths, but also stand-alone devices that may be coupled, from time to time, to such systems that have storage capability. Consequently, the term “network” includes not only a “physical network” 102, 104, but also a “content network,” which is comprised of the data—attributable to a single entity—which resides across all physical networks.

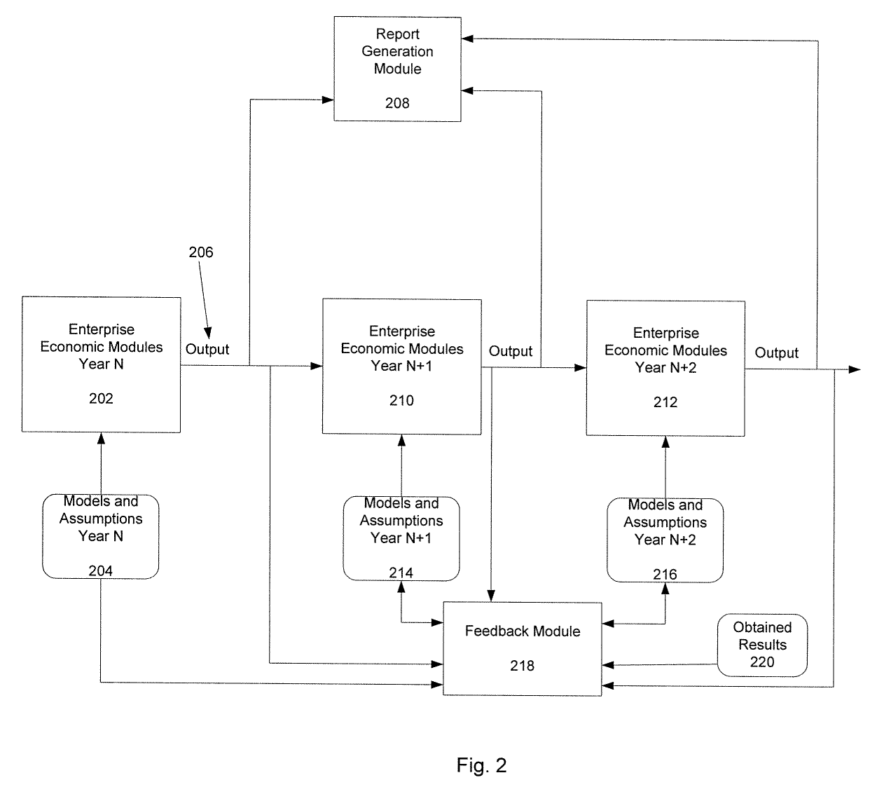

FIG. 2 is a high level diagram of a computer application that allows business decision makers to predict how a business decision will impact an enterprise over a multiyear time period. Enterprise economic modules for year N 202 use models and assumptions 204. Models and assumptions 204 are input values used by the enterprise economic modules. The specific models and assumptions will depend on the types of activities being modeled. Models may include workforce models, sales models, revenue models, equity program models, expense models, etc. Assumptions may include pricing; costs; target workforce mix; partner pyramids; selling, general and administrative expense (SG&A) targets; equity program structure; net revenue; net fees; revenue generated from specific types of work; etc. Exemplary models and assumptions are provided below.

Enterprise economic modules for year N 202 may use models and assumptions 204 to generate an output 206. Output 206 may include a headcount by business unit, margins, pretax earnings per share, cash flow data and any other data that relates to the economic health and vitality of an enterprise. Output 206 may also be delivered to a report generation module 208. Report generation module 208 may be used to create reports, such as a balance sheet or profitability analysis. Those skilled in the art will appreciate that report generation module 208 may be implemented with a stand alone software application or may be integrated with other modules. In one embodiment of the invention, all of the modules and models shown in FIG. 2 are implemented with a spreadsheet workbook, such as an Excel® workbook. As is described in detail below, enterprise economic modules for year N 202 may include several modules that provide data to one another.

Enterprise economic modules for year N+1 210 and enterprise economic modules for year N+2 212 may be included and linked to enterprise economic model modules for other years. Models and assumptions 214 and 216 may be used for the relevant years. Alternatively, two or more sets of enterprise economic modules may use the same models and assumptions. A feedback module 218 may be used to alter assumptions based on obtained results 220. For example, assumptions for Year N 204 may include a net revenue assumption that exceeded the actual obtained net revenue by 10%. This information may be used to reduce the net revenue assumptions included in models and assumptions 214 and 216. In one embodiment of the invention a rules engine and set of rules are used to provide feedback and adjust assumptions. The adjustment of some or all of the assumptions may be automated or require human intervention before being made. For example, after the completion of a fiscal year a report may be generated that lists all assumptions that deviated from actual obtained results by a certain percentage. The report may be presented on a display device and include user interface selection elements that allow a user to make modification to assumptions previously provided for subsequent years.

Feedback module 218 may also be configured to modify or suggest modifications to the models. For example, if one of the economic models has a pattern of producing a headcount that is 7% higher than is actually necessary and the error does not derive from an incorrect assumption, the economic model may be modified to reduce the calculated target headcount by 7%. In another embodiment of the invention, a report would be generated to alert the user to the discrepancies so that the use can analyze the models.

Among other uses, the system diagramed in FIG. 2 allows business decision makers to agree on a set of assumptions, such as pricing, profit margins, target revenue, etc. and then apply the assumptions to economic modules 202, 210 and 212 to predict how the assumptions will impact the economic health and vitality of an enterprise and business units of the enterprise over a multiyear period. The data produced can then be used by the business decision makers to make better decisions. For example, if economic modules 202, 210 and 212 generate results that show that the enterprise's margins can be increased by pricing services lower and increasing the volume of the services the business goals of the enterprise can be adjusted accordingly.

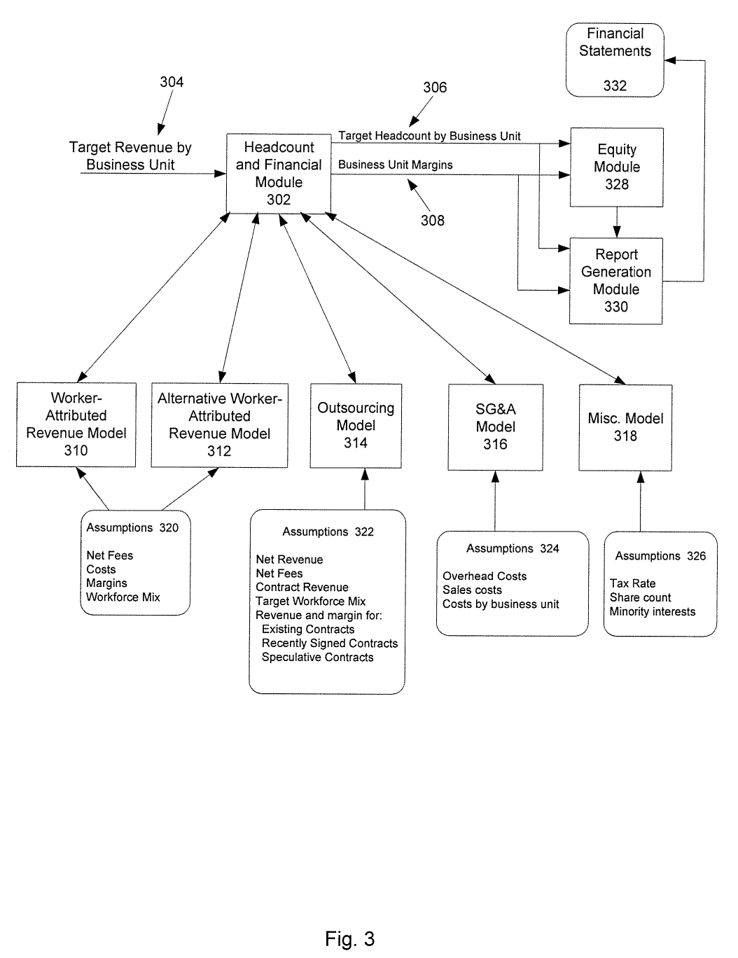

FIG. 3 shows a diagram of a system for generating workforce data, in accordance with an embodiment of the invention. A headcount and financial module 302 may receive an input 304, such as target revenue by business unit. Headcount and financial module 302 may then access one or more models to generate information such as target headcount by business unit 306 and predicted business unit margins 308. A business unit may be considered a logical grouping of workers and functions that they perform. The system shown in FIG. 3 includes a worker-attributed revenue model 310, an alternative worker-attributed revenue model 312, and outsourcing model 314, an SG&A model 316 and a miscellaneous model 318. Each of the models may be designed to generate workforce data for a particular type of workforce. Worker-attributed revenue model 310 may be used to model business units and enterprises in which at least a portion of the revenue generated by the business unit or enterprise is attributed to services provided by workers. For example, worker-attributed revenue model 310 may be used to model economic parameters of consultants, attorneys, dentists, doctors, architects, interior designers, financial planners, accountants and other collections of workers that provide services in exchange for fees. Alternative worker-attributed revenue model 312 is included to show that multiple models may exist for modeling similar workforces. Models may be adapted to account for geographic differences, differences that exist between workforces in different countries, differences that exist between similar business units within an enterprise or any other differences. Outsourcing model 314 may be used to model business units and enterprises in which at least a portion of the revenue generated by the business unit or enterprise derives from outsourcing work performed for other enterprises, such as business process outsourcing, information technology outsourcing, office services outsourcing, call center outsourcing, mailroom outsourcing, etc.

One skilled in the art will appreciate that any number of models may be included and linked to headcount and financial module 302. Alternative models may model economic parameters of business units and/or enterprises that generate revenue by other means, such as by selling or distributing products, adding value to products or providing other services. Models may also model other aspects of workforces, such as workforces that include enterprise workers and external lower cost workers. A model may be used to analyze the impact to a business unit or enterprise of having varying numbers of enterprise workers and external lower cost works.

Each of the modules shown in FIG. 3 is associated with a set of assumptions. Assumptions 320, for example, indicate that consulting model 310 requires values for net fees, price, costs, margins and workforce mix. With assumptions 320 and input 304, headcount and financial module 302 may use worker-attributed revenue model 310 to generate workforce data. Assumptions 322, 324 and 326 are associated with outsourcing model 314, SG&A model 316, and miscellaneous model 318, respectively. Assumptions 320 may be used by both worker-attributed revenue model 310 and alternative worker-attributed revenue model 312. One model may also use a subset of assumptions used by another model.

Some or all of the data generated by headcount and financial module 302 may be sent to other modules, such as an equity module 328 and a report generation module 330. Exemplary equity modules are described below. Report generation module 330 may be similar to report generation module 208 (shown in FIG. 2) and may generate financial statements 332. Financial statements may include balance sheets, cash flow statements, etc. The linking of modules allows data generated by one module to feed another module so that a more complete prediction of economic parameters may be obtained. In one embodiment linking is performed by linking worksheets or other sections of a spreadsheet workbook. The linking of modules allows business decision makers to see how a change will impact numerous economic parameters. For example, altering the target revenue of a business unit might impact a target headcount of the business unit, which may impact the cost of an equity program. If the cost of the equity program reaches an undesired level, business decision makers may alter the structure of the program, which will result in a change to the model used by equity module and/or the associated assumptions. The modules shown in FIG. 3 may also be linked to modules and/or models for generating enterprise economic data for different years. This will allow, for example, a business decision maker to determine how a modification to the target revenue for a business unit in year N will impact the cost of an equity program in year N+5.

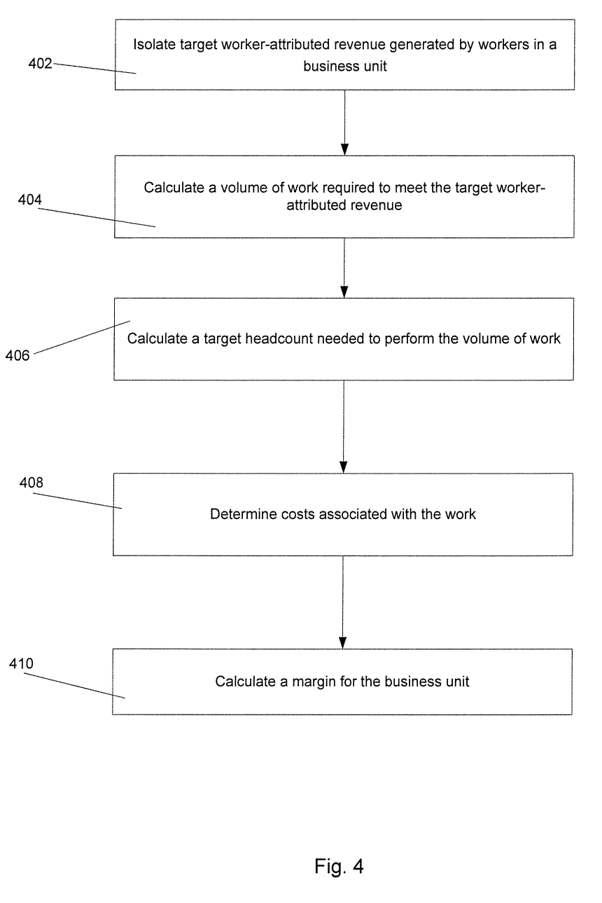

FIG. 4 illustrates exemplary steps performed by a worker-attributed revenue workforce model, such as worker-attributed revenue model 310 (shown in FIG. 3). First, in step 402 target worker-attributed revenue generated by workers in a business unit is isolated from other revenue. Other revenue may include revenue generated by subcontractors, affiliates, alliances or other sources. In step 404 a volume of work required to meet the target consulting revenue is calculated. Step 404 may include dividing the target worker-attributed revenue by an average hourly rate for workers, such as consultants, attorneys, doctors, etc., performing the work. Next, in step 406 the target headcount needed to perform the volume of work is calculated. Step 406 may include analyzing the volume of work and at least one productivity metric. The productivity metric may include a percentage of work performed that is expected to be paid for by clients.

The costs associated with the work may be determined in step 408. Costs may include engagement costs, capital charges, subcontractor costs SG&A and other costs associated with performing the work. Finally, in step 410 the margin for the business unit may be calculated. Step 410 and may include subtracting the cost determined in step 408 from the target worker-attributed revenue. The worker-attributed revenue model may also be configured to calculate a margin for the entire enterprise.

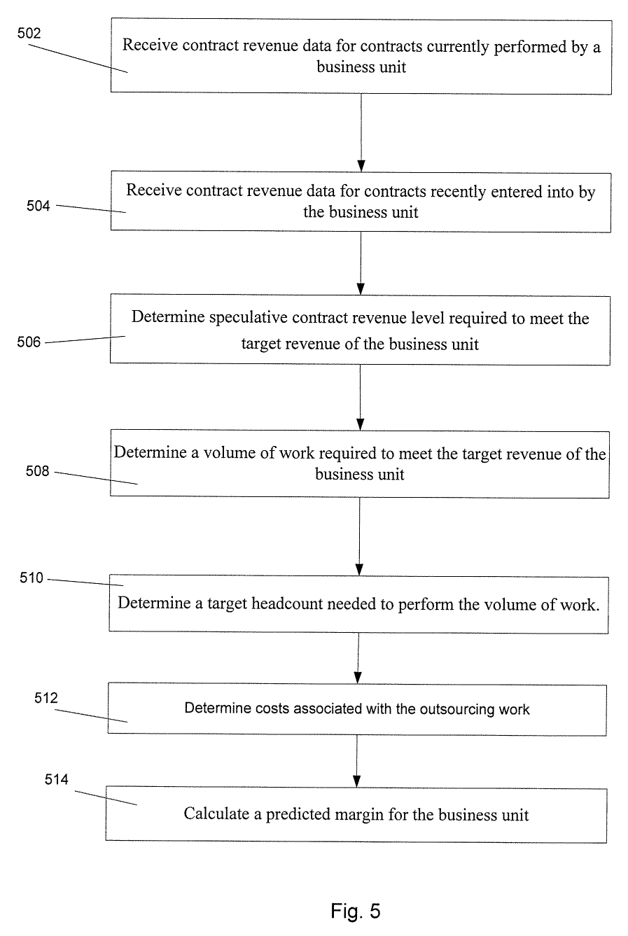

FIG. 5 illustrates exemplary steps performed by an outsourcing workforce model, such as outsourcing model 314 (shown in FIG. 3). First, in step 502 contract revenue data for contracts currently performed by a business unit are received. As used herein, a “contract” is meant to encompass production commitments and other arrangements in which an enterprise provides products and/or services in exchange for a fee. The contract revenue data may include net revenue, price, net fees or any other revenue related data. Next, contract revenue data for contracts recently entered into by the business unit are also received in step 504. In step 506 a speculative contract revenue level required to meet the target revenue of the business unit is determined. Step 506 may include subtracting the need revenue data received in step 502 and the revenue data received in step 504 from a target revenue of the business unit. Current contract revenue data, recently entered into contract data and speculative contract revenue may be grouped separately because the expected margins for each type of revenue may be different. The expected margins obtained for an outsourcing contract may increase during the execution of the contract. Moreover, some models may discount speculative contract revenue to reflect that the revenue is speculative.

Next, a volume of work required to meet the target revenue of the business unit is determined step 508. In step 510 a target headcount needed to perform the volume of work is determined. Step 510 may include analyzing the workforce structure and one or more productivity metrics. Next, in step 512 the costs associated with the outsourcing work are determined and a margin for the business unit is calculated in step 514.

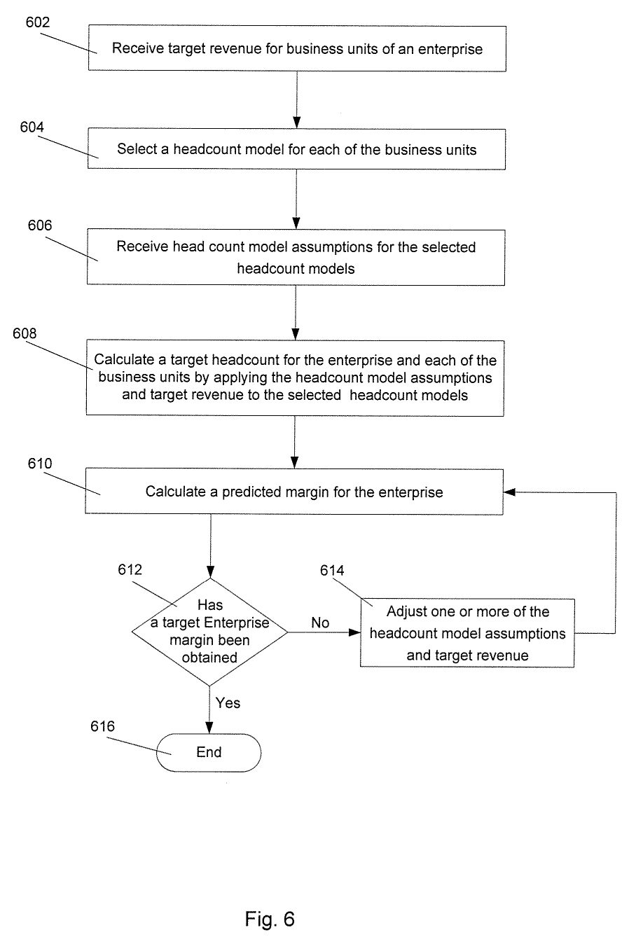

FIG. 6 illustrates a process that may be performed by a workforce module, such as headcount and financial module 302 (shown in FIG. 3). First, in step 602 target revenue for the business units of an enterprise are received. The target revenue may be generated by business decision makers based on business goals of the enterprise. Next, headcount models for each of the business units are selected in step 604. The selection of headcount models may be based on the type of business unit and workforce being model. Step 604 may be performed by a user or may be automated based on answers to a set of questions or other information that can be used to select a model. Next, in step 606 headcount model assumptions for the selected headcount models are received. In step 608 a target headcount for the enterprise and each of the business units is calculated by applying the headcount model assumptions and target revenue to the selected headcount models. After a target headcount is established, a number of other economic parameters may be calculated. For example, in step 610 a predicted margin for an enterprise may be calculated. The predicted margin may result from subtracting enterprise expenses from enterprise revenue. The enterprise expenses and revenue may be functions of the target headcount.

Modifications to any of the inputs and assumptions may be performed to determine the impact of such changes on an enterprise. For example, in step 612 it is determined whether a target enterprise margin has been obtained. When the target enterprise margin has been obtained the process ends in step 616. When the target enterprise margin has not been obtained one or more of the model assumptions and/or target revenue may be adjusted before returning to step 610, where again a predicted margin for the enterprise is calculated. Steps 610, 612 and 614 may be repeated until a target enterprise margin is obtained. One skilled in the art will appreciate that in other embodiments of the invention other parameters may be changed to determine the impact on the enterprise margin or any other economic parameters.

Workforce modules may also be configured to recommend changes across business units. For example, if it is determined that the headcount of a first business unit should be reduced by 20 employees and the headcount of a second business unit should be increased by 30 employees, the workforce module may be configured to determine if the skill sets of the employees are similar and recommend transferring 20 employees from the first business unit to the second business unit.

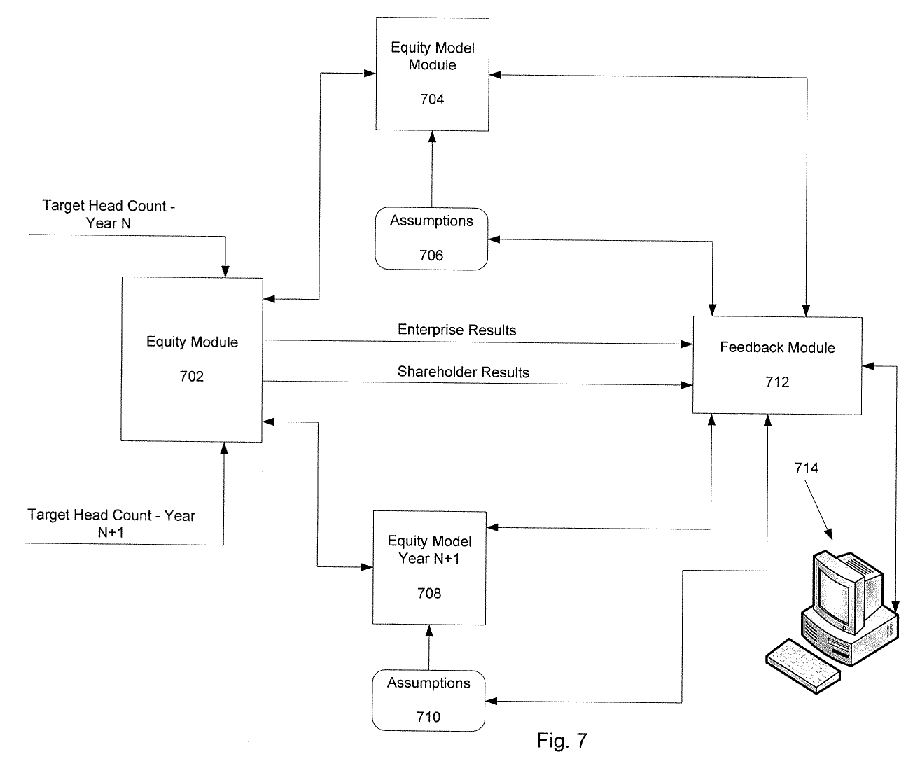

FIG. 7 illustrates a system for calculating the impact of an equity program on an enterprise over a multiyear period. Target headcount data for year N and year N+1 is received at an equity module 702. The target headcount data may be received from a workforce module, such as headcount and financial module 302 (shown in FIG. 3). Equity module 702 may use an equity model for year N 704, a set of assumptions 706 and the target head count data for year N to produce data that indicates the impact of the equity program from the enterprise's view point and the view point of shareholders. Equity program assumptions 706 may include a share price projection, individual tax rates, tax rates paid by the enterprise in various countries, the type of equity program and any other types of information that relating to how an equity program impacts shareholders and the enterprise. Examples of the types of data produced by equity module 702 are provided below.

Some of the data produced by equity module 702 may be used by models for subsequent years. For example, equity module 702 may determine how many stock options will be given to employees in year N by using equity model for Year N 704 and assumptions 706. An equity model for year N+1 708 may use this stock option data when determining how many options will be exercised in a subsequent time period. Equity model for year N+1 708 may also access a set of assumptions 710. In some embodiments of the invention assumptions 706 and 710 may be the same. In other embodiments of the invention assumptions 706 and 710 may be specific to the year for which data is being created.

The system shown in FIG. 7 shows two separate equity models 704 and 708 and two different sets of assumptions 706 and 710. Those skilled in the art will appreciate that in some embodiments of the invention a set of assumptions may be included within the same software code or segment that is depicted as a model. Moreover, a single model may be used to produce data for several years of a multiyear period. For example, instead of including details regarding the year-to-year differences in equity programs in a series of models, the difference may be reflected in sets of assumptions that are used by a single equity model.

The output of equity module 702 may be provided to a feedback module 712. Feedback module 712 may compare assumptions, models, and/or predicted to obtained results so that modifications to models and/or assumptions for subsequent years may be made or suggested. In one embodiment of the invention recommendations for modifications to assumptions and models may be displayed to a user on a computer device 714.

Various feedback mechanisms are described for improving models and assumptions based on obtained results. In alternative embodiments of the invention a feedback module may be used to select models. For example, after actual economic results are obtained, a module may use several different models and associated assumptions to predict the results. A comparison of the obtained results to the results predicted by the models may be used when selecting models for subsequent years. Actual obtained results may also be used to validate assumptions provided by users. For example, if a target revenue assumption for a business unit is provided that exceeds the highest revenue ever obtained by the business unit, a warning or dialog box may be displayed to the user.

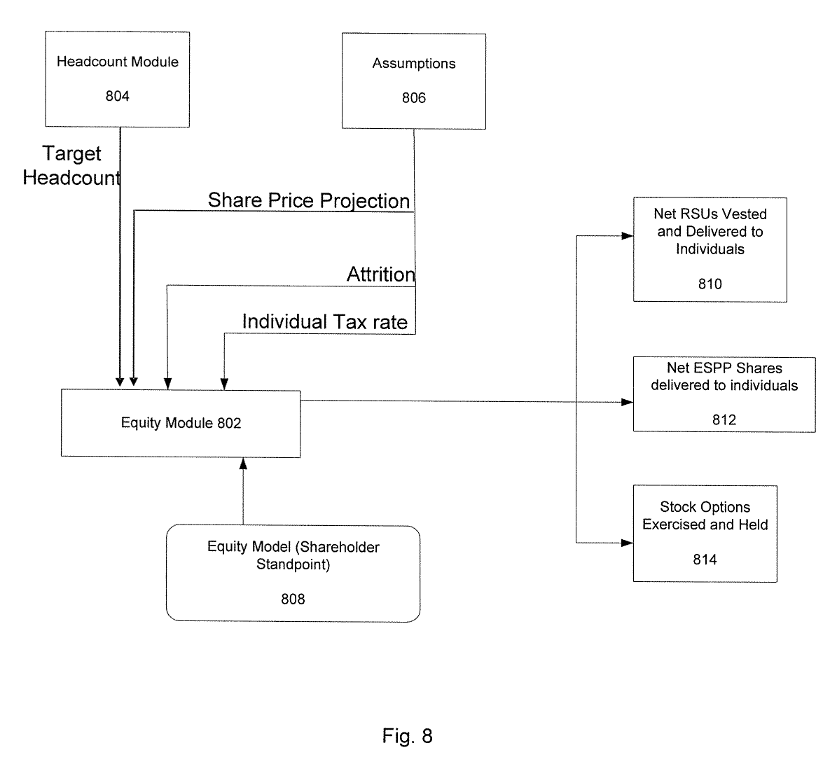

FIG. 8 shows a diagram of a system for generating data that indicates how an equity program will impact shareholders, in accordance with an embodiment of the invention. An equity module 802 may receive target headcount data from a headcount module 804. Equity module 802 may also receive assumptions 806. Assumptions may include information like a projection of an enterprise's share price, attrition rates, individual tax rates, corporate tax rates, etc. Equity module 802 may also access one or more equity models, such as equity model 808. Equity model 808 may be configured to predict how an equity program will impact shareholders. For example, equity model 808 may model may be configured to determine how many restricted stock units (RSUs), stock options, employee stock purchase plan (ESPP) shares and other securities that will be granted, purchased and vested within a given time frame. With assumptions 806, the target headcount and equity model 808, equity module 802 may predict information such as the net restricted stock units vested and delivered to individuals 810, the net employee stock purchase plan shares delivered to employees 812 and the number of stock options granted, exercised and held 814.

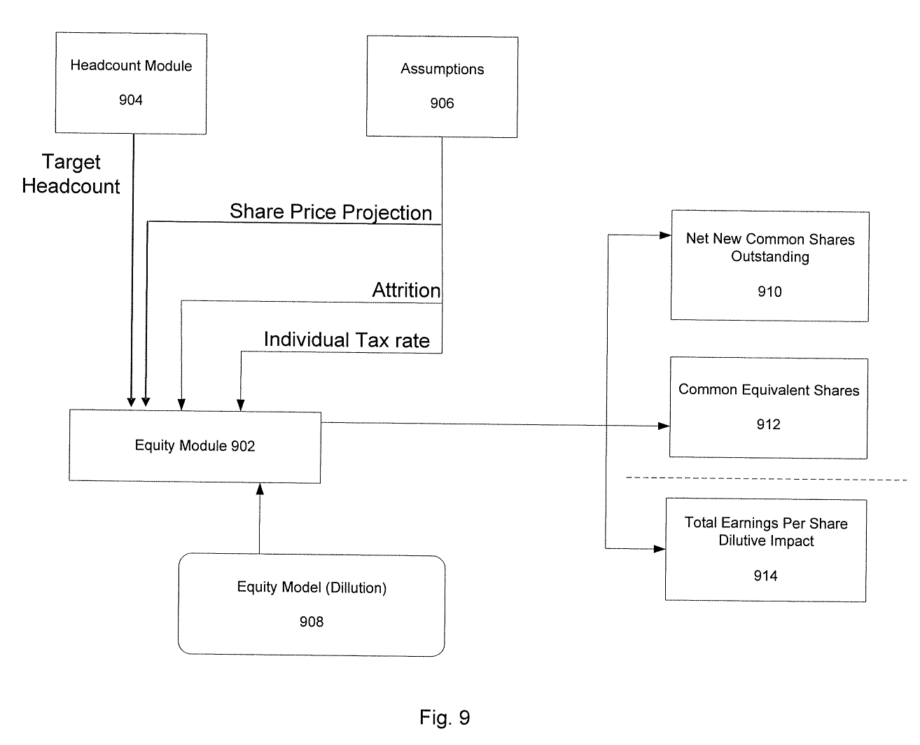

FIG. 9 shows a diagram of a system for generating data relating to the dilution impact of an equity program, in accordance with an embodiment of the invention. An equity module 902 may receive target headcount data from a headcount module 904. Equity module 902 may also receive assumptions 906. Assumptions may include information like a projection of an enterprise's share price, attrition rates, individual tax rates, corporate tax rates, etc. Equity module 902 may also access one or more equity models, such as equity model 908. Equity model 908 may be configured to predict how an equity program will have a dilution impact on existing shares. For example, equity model 908 may be configured to determine how a program that provides stock options to employees will impact the enterprise's earnings per share (EPS). With assumptions 906, the target headcount and equity model 908, equity module 902 may predict information such as the net new common shares that will be outstanding 910, a number common equivalent shares 912 and a total earnings per share dilutive impact 914. Total earnings per share dilutive impact 914 may be the sum of 910 and 912.

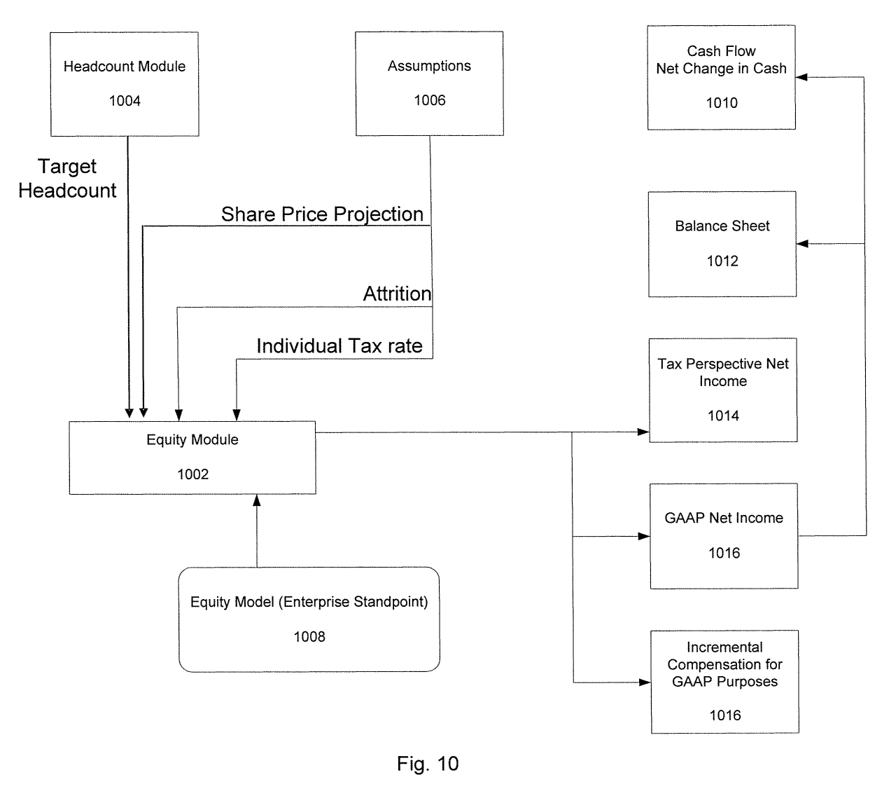

FIG. 10 shows a diagram of a system for generating data relating to how an equity program impacts an enterprise, in accordance with an embodiment of the invention. An equity module 1002 may receive target headcount data from a headcount module 1004. Equity module 1002 may also receive assumptions 1006. Assumptions may include information like a projection of an enterprise's share price, attrition rates, individual tax rates, corporate tax rates in various countries, tax credits, etc. Equity module 1002 may also access one or more equity models, such as equity model 1008. Equity model 1008 may be configured to predict how an equity program will impact an enterprise. For example, equity model 1008 may be configured to determine how a program that provides securities to employees will impact the enterprise's income and incremental compensation. With assumptions 1006, the target headcount and equity model 1008, equity module 1002 may predict information such as the net income from a tax perspective 1014, net income according to general accepted accounting principles (GAAP) 1016 and the incremental compensation 1018. Net income according to general accepted accounting principles (GAAP) 1016 may be used by equity module 1002 or another module to calculate cash flow statement 1010 and/or a balance sheet statement 1012.

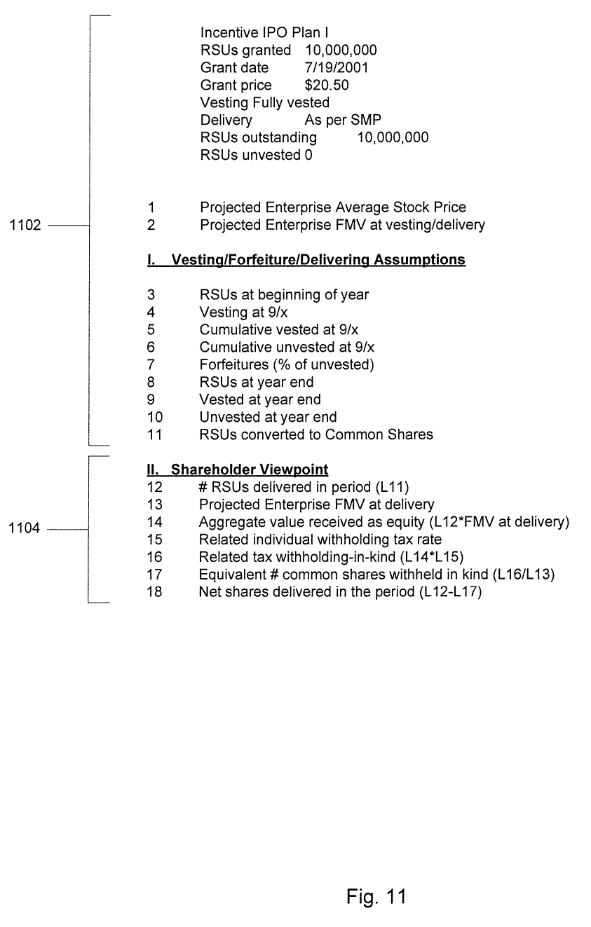

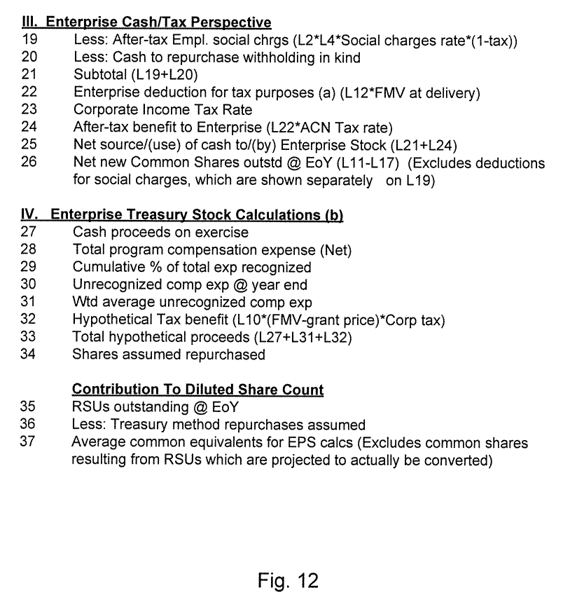

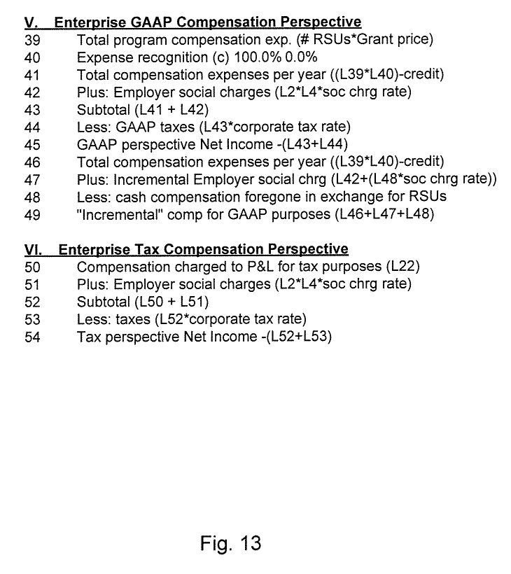

The modules, models and assumptions described herein are not required to be implemented with separate computer applications or files. In some embodiments of the invention a module is implemented with a computer device running a spreadsheet application, such as Excel®. Assumptions may be in the form of spreadsheet workbook entries and models may be implemented with workbook formulas. FIGS. 11-13 illustrate exemplary assumptions and formulas that may be used to implement RSU equity models and assumptions. FIG. 11 illustrates assumptions in section 1102 and formulas to implement a model for determining the impact of an equity program on shareholders in section 1104. As used in the formulas, “L” represents a previous line number and may be equivalent to a worksheet column. FIG. 12 illustrates exemplary assumptions and formulas that may be used to implement a model that determines the dilution impact of an equity program, in accordance with an embodiment of the invention. FIG. 13 illustrates exemplary assumptions and formulas that may be used to implement a model that determines how an equity program impacts an enterprise, in accordance with an embodiment of the invention. Of course the assumptions and formulas shown in FIGS. 11-13 may be expanded to cover multiyear time periods.

In alternative embodiments of the invention, the disclosed modules may be implemented with rules engines and the various models and assumptions may be in the form of rules used by the rules engines.

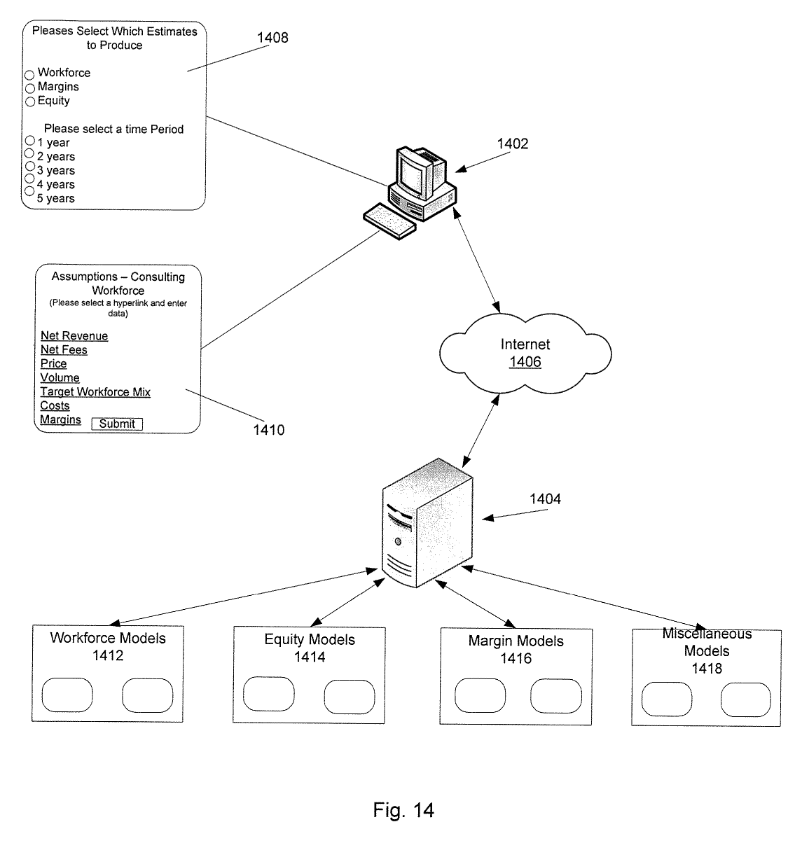

Aspects of the invention may also be used to provide web services, which may be free or fee based. FIG. 14 shows a system in which a user may request estimates of economic parameters via a wide area network, in accordance with an embodiment of the invention. A user computer device 1402 may be linked to a server computer device 1404 via the Internet 1406. Server computer 1404 may transmit information to user computer device 1402 that describes the type of estimate services available and the assumption values needed. A webpage 1408 lists the types of estimates that may be provided. Estimates may relate to workforces, margins, equity programs and any other economic estimates that would be of value to an enterprise. After the type of estimate is selected, a second webpage 1410 may prompt the user for assumption values. The assumption values needed may be a function of the type of estimate selected.

Server computer 1404 may access a variety of different models, such as workforce models 1412, equity models 1414, margin models 1416 and miscellaneous models 1418. In some embodiments of the invention the models are kept as trade secrets and users are only provided with results.

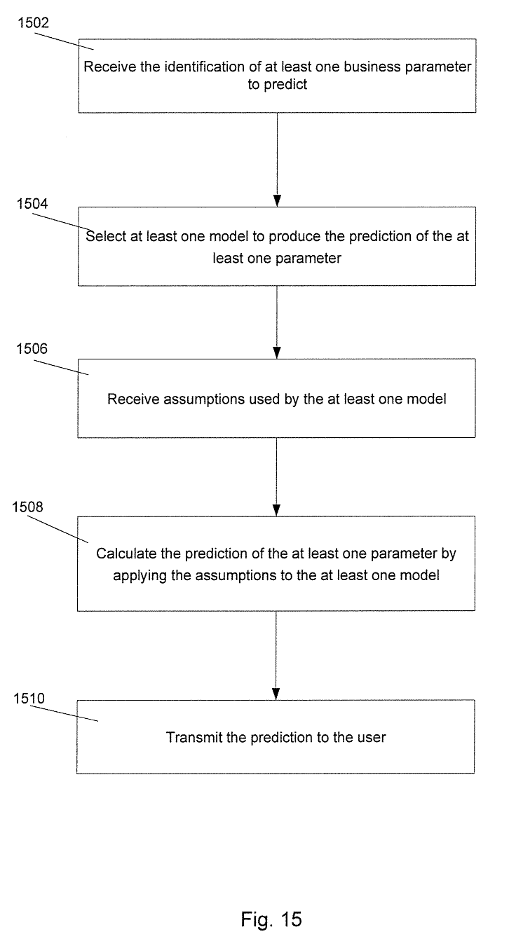

FIG. 15 illustrates a method that may be performed by a computer device to predict business parameters, in accordance with an embodiment of the invention. First, in step 1502 the identification of at least one business parameter to predict is received. The business parameter may be selected on a user interface displayed on computer device 1402 and may be received at server computer 1404. Next, at least one model to produce the prediction of the at least one parameter is selected in step 1504. The model may be selected by a user or a server computer. In step 1506 assumptions that are required by the at least one model are received. Next, the prediction of the business parameter is calculated by applying the assumptions to the selected model in step 1508. Finally, the prediction is transmitted to the user in step 1510.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

We claim:

1. A computer-implemented method of determining a target headcount for an enterprise having a plurality of business units, the method comprising:
(a) receiving target revenue for each of the business units;
(b) selecting a headcount model for each of the business units;
(c) receiving headcount model assumptions for the selected headcount models; and
(d) calculating, using a computer, a target headcount for the enterprise and each of the business units by applying the headcount model assumptions and target revenue to the selected headcount models.

2. The computer-implemented method of claim 1, wherein at least one headcount model includes a worker-attributed revenue headcount model that includes:
(i) isolating target worker-attributed revenue generated by workers in each of the business units;
(ii) determining a volume of work required to meet the target worker-attributed revenue; and
(iii) determining a target headcount needed to perform the volume of work.

3. The computer-implemented method of claim 2, wherein (iii) includes analyzing the volume of work and at least one productivity metric.

4. The computer-implemented method of claim 2, wherein (iii) includes determining a target workforce mix.

5. The computer-implemented method of claim 1, further including
(e) calculating a predicted margin for each of the business units.

6. The computer-implemented method of claim 5, further including:
(f) calculating a predicted margin for the enterprise.

7. The computer-implemented method of claim 6, further including
(g) adjusting one or more of the headcount model assumptions and target revenue to obtain a target margin for the enterprise.

8. The computer-implemented method of claim 1, further including;
(e) receiving modified headcount model assumptions for at least one of the selected headcount models; and
(f) calculating, using a computer, a target headcount for the enterprise and each of the business units by applying the headcount model assumptions, the modified headcount model assumptions and target revenue to the selected head count models.

9. The computer-implemented method of claim 8, further including:
(g) generating a report that identifies how the modified headcount model assumptions impacted the target headcount.

10. The computer-implemented method of claim 1, wherein at least one headcount model includes an outsourcing headcount model that includes:
(i) receiving contract revenue data for contracts currently performed by a business unit;
(ii) receiving contract revenue data for contracts recently entered into by the business unit; and
(iii) determining speculative contract revenue level required to meet the target revenue of the business unit.

11. The computer-implemented method of claim 10, wherein the outsourcing headcount model further includes:
(iv) determining a volume of work required to meet the target revenue of the business unit; and
(v) determining a target headcount needed to perform the volume of work.

12. The computer-implemented method of claim 10, further including:
(iv) calculating a predicted margin for the business unit.

13. The computer-implemented method of claim 12, wherein the expected margin resulting from contracts currently performed by a business unit increases over time.

14. The computer-implemented method of claim 10, further including calculating a revenue flow report.

15. The computer-implemented method of claim 10, further including creating a margin profile for each type of contract.

16. The computer-implemented method of claim 15, wherein the expected margins resulting from contracts currently performed by a business unit increase over time.

17. A computer-implemented method of determining the impact of an enterprise equity program on shareholders, the method comprising:
(a) receiving a target headcount;
(b) selecting an equity model that models the equity program;
(c) receiving equity model assumptions for the selected equity model; and
(d) calculating, using a computer, at least one parameter that reflects the impact of the equity program on shareholders by applying the equity model assumptions and target headcount to the selected equity model.

18. The computer-implemented system of claim 17, wherein the at least one parameter includes a number of restricted stock units delivered to employees within a predetermined time period.

19. The computer-implemented system of claim 17, wherein the at least one parameter includes a number of stock options delivered to employees within a predetermined time period.

20. The computer-implemented system of claim 17, wherein the at least one parameter includes a number of ESPP (Employee Share Purchase Plan) shares purchased by employees within a predetermined time period.

21. The computer-implemented method of claim 17, wherein (d) comprises calculating a dilution impact of the equity program.

22. The computer-implemented method of claim 17, further including:
(e) calculating, using a computer, at least one parameter that reflects the impact of the equity program on the enterprise.

23. The computer-implemented method of claim 22, wherein (e) comprises calculating net income of the enterprise.

24. The computer-implemented method of claim 22, wherein (e) comprises calculating cash flow of the enterprise.

25. A computer-implemented method of estimating how business decisions will impact an enterprise, the method comprising:
(a) receiving at a first computer device the identification of at least one business parameter to predict from a second computer device connected to the first computer device via a wide area network;
(b) selecting at least one model to produce the prediction of the at least one parameter;
(c) receiving assumptions used by the at least one model; and
(d) calculating the prediction of the at least one parameter by applying the assumptions to the at least one model.

26. The computer-implemented method of claim 23, further including transmitting the prediction to the second computer device via the wide area network.

27. The computer-implemented method of claim 23, wherein the at least one model includes a model that estimates a target headcount.

28. The computer-implemented method of claim 23, wherein the at least one model includes a model that estimates the impact of an equity program on an enterprise.
